(19) United States
(12) Patent Application Publication
(10) Pub. No.: US 2008/0046839 A1
(43) Pub. Date: Feb. 21, 2008

(54) INPUT MODE SWITCHING METHODS AND DEVICES UTILIZING THE SAME

(75) Inventors: Sukrit Kumar Mehra, Meerut (IN); Arun Gupta, Faridabad (IN); Vikram Salwan, New Delhi (IN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: PIXTEL MEDIA TECHNOLOGY (P) LTD., Noida (IN)

(21) Appl. No.: 11/745,633

(22) Filed: May 8, 2007

(30) Foreign Application Priority Data
Jun. 27, 2006 (IN) 1502/DEL/2006

(51) Int. Cl. G06F 3/048

(52) U.S. Cl. 715/810

(57) ABSTRACT

An input mode switching method is disclosed. A plurality of optional input modes are provided for character input. A subset of the input modes is selected as the total options selectable through a first control interface during character input.

### CROSS REFERENCE TO RELATED APPILCATIONS

This application claims the benefit of Indian Provisional Application No. 1502/De1/2006, filed 2006.6.27.

### BACKGROUND OF THE INVENTION

1. Field of the Invention

The invention relates to computer techniques, and more particularly to methods and devices for switching between input methods.

2. Description of the Related Art

Currently a mobile phone may have multiple input modes that can be sequentially chosen as the current input mode to input text, numbers, symbols, and other characters. The sequence of input mode switching is set before the mobile phone leaves the factory. A user must sequentially iterate through the sequence to select one of these input modes. As input modes are increasingly supported, switching therebetween becomes more burdensome.

### BRIEF SUMMARY OF THE INVENTION

An exemplary embodiment of an input mode switching method comprising the following steps is implemented in an electronic device. A plurality of optional input modes are provided for character input. A subset of the input modes is selected as the total options selectable through a first control interface of the device while entering characters.

An exemplary embodiment of an input mode switching method comprising the following steps is implemented in an electronic device. A plurality of optional input modes are provided for character input and arranged in a predefined sequence to be orderly and exclusively switched on. A subset of the input modes is selected by which the electronic device obtains a new sequence of input mode switching during character input. The method may be utilized to provide a toggle function in which input mode switching is focused on a pair of input modes, such as the currently and the last used modes. A device implementing the method may provide a UI for switching between the currently and the last used modes.

An exemplary embodiment of an electronic device capable of input mode switching comprises an input device and a processor. The input device is capable of character input via a plurality of optional input modes. The processor selects a subset of the input modes as the total options selectable through a first control interface of the input device during character input.

An exemplary embodiment of an electronic device capable of input mode switching comprises an input device and a processor. The input device is capable of character input via a plurality of optional input modes arranged in a predefined sequence by which respective input modes are to be orderly and exclusively switched on. The processor selects a subset of the input modes by which a new sequence of input mode switching is obtained by the electronic device during character input.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flowchart of exemplary operations for entering a message;

FIG. 2 is a flowchart for creating a subset of input mode switching;

FIG. 3 is a block diagram of an exemplary embodiment of an electronic device;

FIG. 4 is a schematic view showing an exemplary user interface for customizing an input mode list;

FIG. 5 is a flowchart of exemplary operations for entering the same message with the user definition function;

FIG. 6 is a flowchart showing the exemplary operations of automatic input mode selection;

FIG. 7 is a flowchart of exemplary operations for entering the same message with the automatic selection function;

FIG. 8 is a flowchart showing the exemplary input mode switching in a toggle mode;

FIG. 9 is a flowchart of exemplary operations for entering the same message with the toggle function; and

FIG. 10 is a schematic view showing an exemplary user interface for activating respective input mode switching functions.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Input mode switching methods and devices are provided. Typically, a device may provide many input modes only one of which, referred to as the current input mode, is active during character input. The current input mode is referred to as the currently used input mode when currently and actually utilized to input at least one character, and referred to as the last used input mode when switched off. For example, a first input, when currently switched on and utilized to input at least one character mode, is referred to as the currently used input mode. When the first input mode is switched off, a second input mode following the first input mode is switched on as the current input mode, and the first input mode is referred to as the last used input mode. Similarly, the second input mode is referred to as the currently used input mode when currently and actually utilized to input at least one character, and referred to as the last used input mode when switched off.

Although a device may have many input modes, there may be only a portion thereof needed during message editing, leaving the remaining input modes to be iterated through for switching between desired input modes. For example, a mobile phone as shown in Table 1 supports 11 input modes:

TABLE 1
Input mode list

| | |
|---|---|
| 1. | Smart English |
| 2. | Capital English ABC |
| 3. | Normal English abc |
| 4. | Simplified Chinese |
| 5. | Smart Simplified Chinese |
| 6. | Traditional Chinese |
| 7. | Normal Thai |
| 8. | Smart Thai |
| 9. | Numeric |
| 10. | Symbol |
| 11. | Smileys |

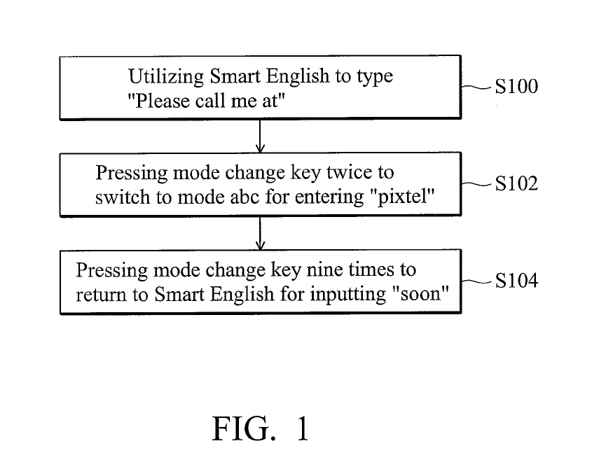

A dedicated mode change key may be set on the mobile phone to switch from the first input mode to the eleventh, and repeatedly to the first. To type a message “Please call me at pixtel soon” utilizing the mobile phone, where the “pixtel” is absent in a built-in dictionary accessible by the Smart English input method, operations shown in FIG. 1 are required. With reference to FIG. 1, the first input mode, Smart English, is utilized to type “Please call me at” (step S100). The input mode change key is pressed two times to switch to third mode abc for entering “pixtel” (step S102) and pressed nine times to return to Smart English to enter “soon” (step S104). The mode change key is thus pressed a total of 11 times.

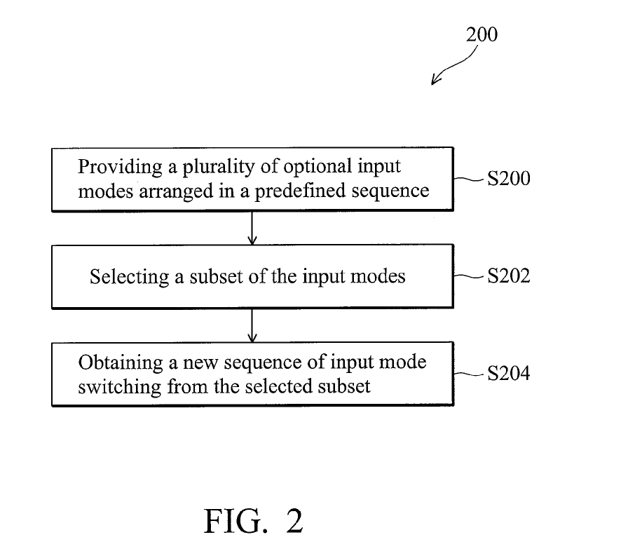

The predetermined input mode list of an electronic device implies the sequence of switching input modes. Thus, a proposed input switching method may reduce the list and change the input mode switching sequence. With reference to FIG. 2, an electronic device provides a plurality of optional input modes (such as those in table 1) for character input, arranged in a predefined sequence to be orderly and exclusively switched on (step S200), selects a subset of the input modes (step S202), and utilizes the selected subset to provide a new input mode switching sequence during character input (step S204). The selected subset may comprise at least one input mode serving as the entire options selectable by the mode change key or other means, to thus shorten the length of the input mode list. Input modes may be manually or automatically selected to be added to the subset. The number of input modes included in the subset may be limited to a predetermined number. A user interface (UI) for setting the predetermined number may be provided. Additionally, the arrangement of respective input modes in the input mode switching sequence may also be adjusted according to utilization of respective input modes.

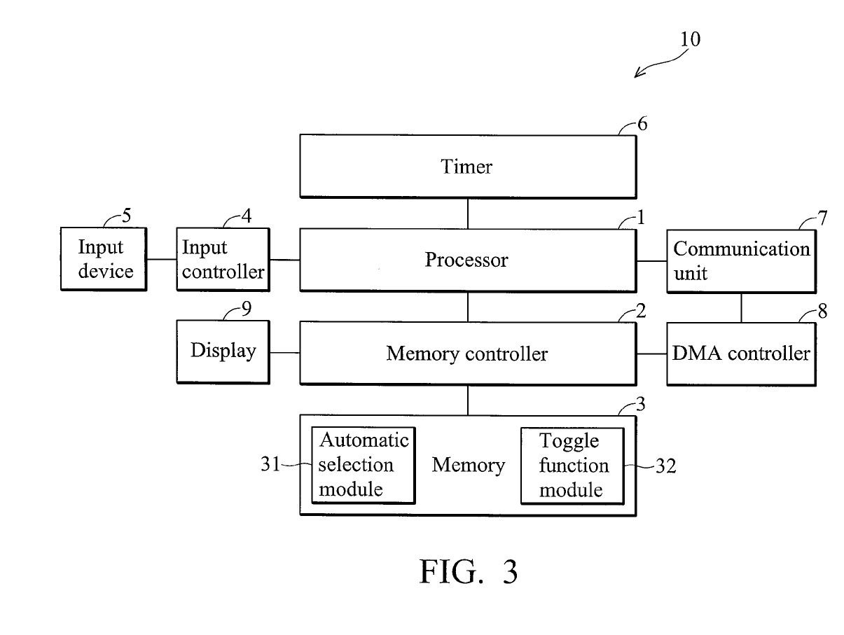

Input mode switching method 200 may be implemented in an electronic device, such as a mobile phone, a smart phone, a personal digital assistant (PDA), a desktop or notebook computer, a game console, or any other suitable electronic device. An exemplary electronic device implementing the method is shown in FIG. 3.

Hardware Configuration

With reference to FIG. 3, electronic device 10 may comprise a mobile phone, a personal digital assistant (PDA), a laptop computer, a tablet personal computer (PC), or any other device capable of character input. Preferably, electronic device 10 comprises an embedded system with limited resources.

In electronic device 10, processor 1 controls operation of the entire system as it fetches and executes software codes stored in memory 3. Memory controller 2 serves as the bridge between processor 1 and memory 3 to transfer data therebetween. Input controller 4 detects states of input device 5 and provides input signals accordingly to processor 1. Input device 5 may comprise a keypad, a touch panel, a touch display, and/or a voice control device by which input modes may be switched and selected for character input. Note that input modes may be switched and selected via any control interface such as voice commands, a mechanical button on the keypad, a virtual button, drop list, or other graphical user interface (GUI) element shown on display 9.

Timer 6 provides timing information to processor 1, so that processor 1 can determine the occurrence time of certain events, such as switch on/off of input modes, and duration, the starting and/or ending time of utilizing an input mode. Timer 6 may comprise a plurality of timing devices, such as a clock reporting current time and a timer triggering events or operations. Display 9 may be used to display the current input mode and the input mode list.

Communication unit 7 receives and transmits data through a cabled or wireless communication channel. Communication unit 7 may comprise infrared, radio frequency (RF), Bluetooth, or other transceiver. Additionally, when the method is embodied in a mobile phone, communication unit 7 can be a cellular MODEM unit, such as a GSM/GPRS/EDGE or W-CDMA or CDMA communication module, which communicates with the cellular network in compliance with the GSM/GPRS/EDGE or W-CDMA or CDMA standards.

In some embodiments of the electronic device, two components (such as processor 1, memory controller 2, memory 3, or DMA controller 6) may be integrated into a single chip. Some embodiments of the electronic device may comprise only a portion of the elements in FIG. 3 with the others excluded.

Electronic device 10 may perform method 200, some exemplary embodiments of which are shown in the following.

User Definition Function: a User-Defined List of Input Modes

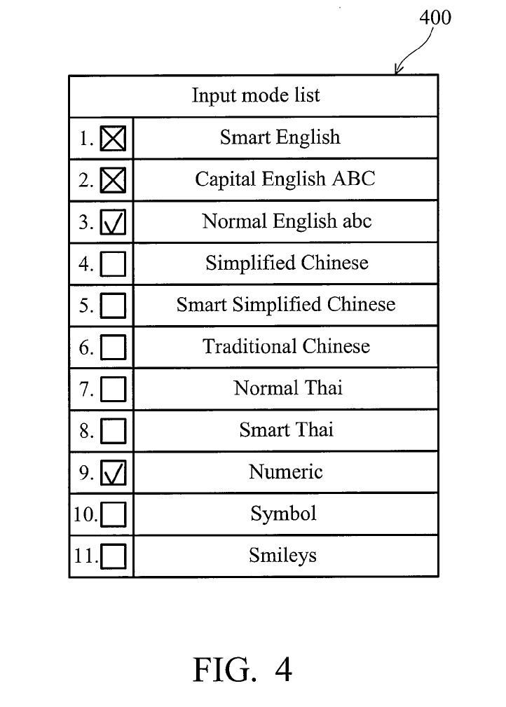

In the first embodiment of method 200, electronic device 10 provides a necessary UI to create a customized list of input modes, such as those the user thinks to be most useful and preferred. FIG. 4 shows the exemplary GUI for selecting input modes, in which each item in list 400 comprises a corresponding check box. The first, second, third, ninth, and tenth input modes are selected to form a customized list with Smart English set as the default, as shown in table 2.

TABLE 2
Input mode list

| New | Old | |
|---|---|---|
| rank | rank | |
| 1 | 1. | Smart English (default) |
| 2 | 2. | Capital English ABC |
| 3 | 3. | Normal English abc |
| 4 | 9. | Numeric |
| 5 | 10. | Symbol |

Note that the GUI layout may be modified, and check boxes may be replaced by hyperlinks or other means. Once the customized list is created, only the input modes therein are iterated through on operation of the control interface (such as the ‘Hash Key’, any other key, or other means) for input mode selection, thus reducing the effort required to navigate the entire list for input mode switching. Thus, less control interface operations (such as key presses) are required to type the message “Please call me at pixtel soon”. A first key is described as an example of the control interface capable of performing input mode switching in the customized list while other means can be utilized to change the current input mode. The first key may be the same as or different from the previously described input mode change key.

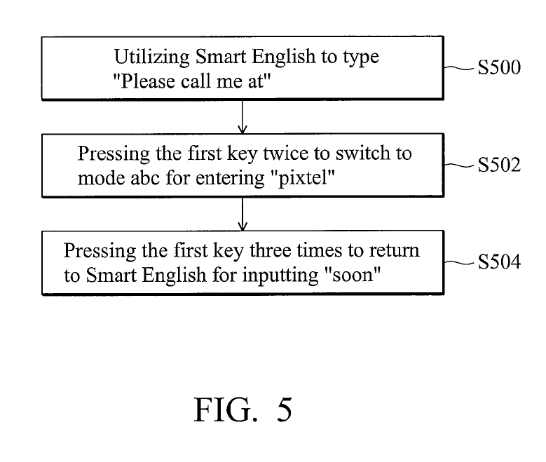

With reference to FIG. 5, the first input mode Smart English is utilized to type “Please call me at” (step S500). The first key is pressed two times to switch to third mode abc for entering “pixtel” (step S502) and pressed three times to iterate through 4^{th} input mode “Numeric”, 5^{th} input mode “Symbol”, and return to 1^{st} input mode “Smart English” for inputting “soon” (step S504). The first key is thus pressed a total of five times.

Automatic Selection Function: a Auto-Generated List of Input Modes

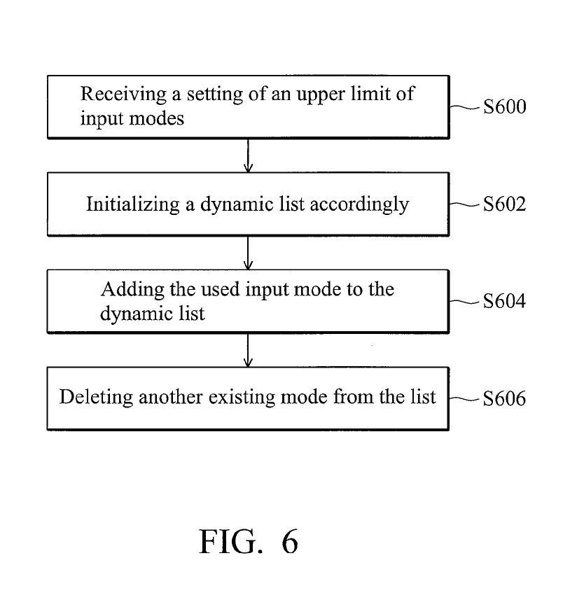

The second embodiment of method 200 builds a dynamic list of input modes based on the current usage patterns of the mobile device and only the modes in the dynamic list are iterated through on the press of a second key for input mode selection. Automatic selection module 31 in memory 3 may implement the embodiment of the method. Automatic selection module 31 may be composed of computer programs executable by processor 1. FIG. 6 shows the exemplary operation of automatic selection module 31.

With reference to FIG. 6, module 31 receives a setting of an upper limit number of input modes in the dynamic list (step S600) and accordingly creates or initializes the list (step S602). The dynamic list may be created as an empty list or a list with predetermined or user-defined input modes. Another interface (such as the second key) or the same first key may be used to switch between input modes in the list. If an identical interface (such as the first key) is utilized for switching between input modes in two lists (such as the customized list and the dynamic list), device 10 must provide another control interface to switch between these two lists. An input mode is referred to as a used input mode if used or recently used for text entry. When a used input mode is detected, module 31 may add the used input mode to the dynamic list (step S604). If the number of input modes in the dynamic list exceeds the upper limit, module 31 may delete another existing mode from the list (step S606). Thus, the dynamic list may act as a FIFO (first in first out) queue with the most recently used input modes.

The second embodiment may be used in conjunction with the first embodiment. For example, when the upper limit is set to three, and the dynamic list is initially empty. When the second, third, and the fourth items (i.e. Capital English ABC, Normal English abc, and Numeric) in table 2 are respectively utilized to input at least one character, these three items are added to the dynamic list, as shown in table 3.

TABLE 3
Input mode list

| New | Old | |
|---|---|---|
| rank | rank | |
| 1 | 2. | Capital English ABC |
| 2 | 3. | Normal English abc |
| 3 | 9. | Numeric |

When the mode Smart English is utilized to input at least one character, the dynamic list is updated as shown in table 4.

TABLE 4
Input mode list

| New | Old | |
|---|---|---|
| rank | rank | |
| 1 | 1. | Smart English |
| 2 | 2. | Capital English ABC |
| 3 | 3. | Normal English abc |

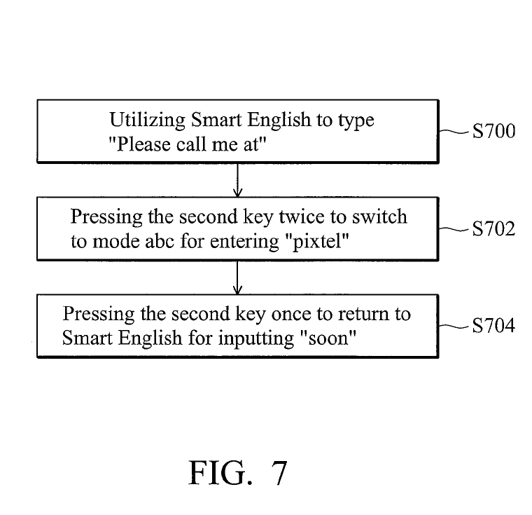

The last used mode Smart English is added to the dynamic list, and the mode Numeric is removed. With reference to FIG. 7, when typing the same message “Please call me at pixtel soon.”, the first input mode Smart English is utilized to type “Please call me at” (step S700). The second key is pressed twice to switch to third mode abc for entering “pixtel” (step S702) and pressed once to return to Smart English for entry of “soon” (step S704). A total of 3 presses of the hash key are required.

Other algorithms may be utilized to manage the dynamic list. For example, module 31 may measure the frequency of usage of respective input modes, automatically add the most frequently used input mode to the dynamic list and remove the least used. Frequency measurement may be implemented in various ways. For example, for each input mode, module 31 measures the duration of mode utilized for input of characters to the device, and determines that an input mode with the longest duration is the most frequently used input mode. Timer 6 may be utilized to measure the duration. Alternatively, for each input mode, module 31 counts the number of times that the mode is selected and utilized to input at least one character to the device; and determines that the most used input mode is the most frequently used input mode. Further, module 31 may count the quantity (words or letters) of characters input to the device utilizing respective input mode, and determines that an input mode inputting most characters is the most frequently used input mode. Thus, the most and least frequently used input modes may be located based on the measured duration, counted times, input characters, or the combination thereof. Accordingly, the dynamic list of input modes can be automatically generated according to the utilization of each input mode.

Toggle Function: a Customized Switching Sequence

The third exemplary embodiment of method 200 changes the sequence of input mode switching and focuses on a pair of input modes, such as the currently and the last used modes. Device 10 provides a UI for switching the toggle function ON or OFF. In the toggle function, processor 1 first presents the last used input as the current input mode and then iterates through remaining available input modes in response to successive requests for input mode switching. The third exemplary embodiment facilitates frequent switching back and forth between two input modes for text editing on mobile devices.

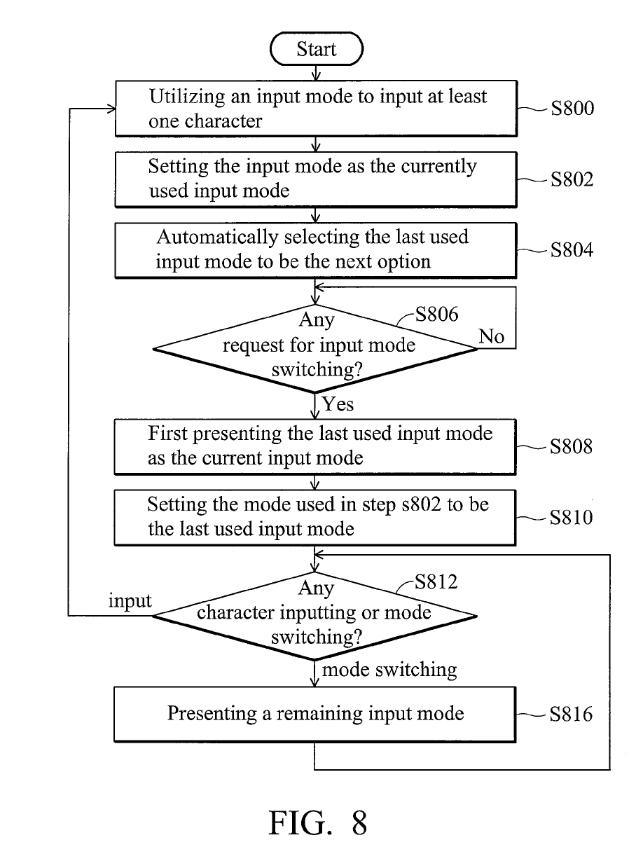

The toggle function may be applied to any input mode list, such as the customized, the dynamic, or the original list. Toggle function module 32 in memory 3 may implement the third embodiment of the method. Module 32 may be composed of computer programs executable by processor 1. FIG. 8 shows the exemplary operation of module 32.

With reference to FIG. 8, when an input mode (e.g. a first input mode) is utilized to input at least one character (step S800), module 32 sets the input mode as the currently used input mode (step S802) and automatically selects the last used input mode (e.g. a second input mode) to be the next option following the currently used input mode in input mode switching sequence (step S804). Module 32 determines if any request for input mode switching is received by processor 1 (step S806). If so, module 32 first presents the next option, i.e. the last used input mode, as the current input mode (step S808) and set the mode used in step S802 (e.g. the first input mode) to be the last used input mode (step S810). Module 32 determines if the current input mode (e.g. the second input mode) is utilized to for input. That is, module 32 determines if character input or mode switching is performed (step S812). If the current input mode (e.g. the second input mode) is utilized to input something, step S800 is repeated. For example, the second input mode is set as the currently used input mode in step S802, and the first input mode is selected as the next option in step S804 and presented as the current input mode in step S808.

In step S812, if an input mode switching request is received, module 32 presents a remaining input mode (such as the item next to the second input mode) (step S816), and repeats step S812.

For example, the toggle function is applied on the list in table 4, and the third mode Normal English abc is the last used input mode. The original switching sequence comprises Smart English, Capital English ABC, and Normal English abc, i.e. “1, 2, 3” in new ranks and repeats the same. With reference to FIG. 8, when the toggle function is on during typing the same message “Please call me at pixtel soon.”, the first input mode Smart English is utilized to type “Please call me at” (step S800) and is set as the currently used input mode (step S802). The third mode Normal English abc is selected to be the next option in the input mode switching sequence (step S804). When the second key is pressed once (step S806), the third mode is presented as the current input mode (step S808). The first mode Smart English is set to be the last used input mode (step S810). The third mode Normal English abc is utilized for entering “pixtel” (step S800) and set as the currently used input mode (step S802). The first mode Smart English is selected as the next option (step S804) and, when the second key is further pressed once, is presented as the current input mode to enter “soon” (step S808). Thus, the new switching sequence comprises new ranks “1, 3, 1”, different from the original sequence. When the second key is then successively pressed seven times without any character input, “1, 3, 1” is followed by “3, 1, 2, 3, 1, 2, 3”, totally providing a switching sequence “1, 3, 1, 3, 1, 2, 3, 1, 2, 3”, wherein the last “2, 3, 1, 2, 3” follows the original sequence.

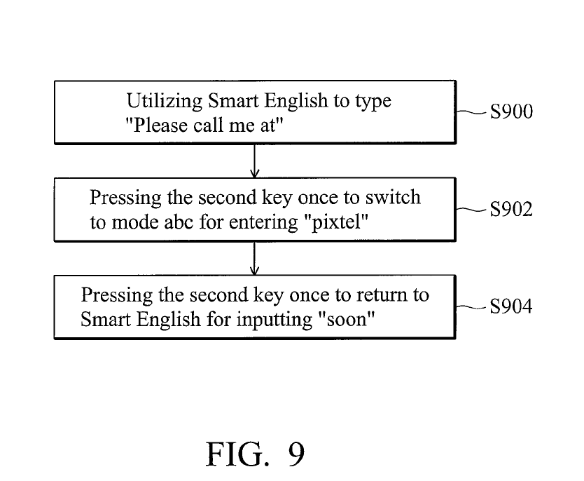

In view of user operations, with reference to FIG. 9, the first input mode Smart English is utilized to type “Please call me at” (step S900). The second key is pressed once to switch to third mode abc for entering “pixtel” (step S902) and pressed once to return to Smart English for inputting “soon” (step S904). The second key is thus pressed a total of two times.

Additionally, in some embodiments, a user-defined input mode or the most frequently used may be selected as the next option in step S804. Mainly, in the third embodiment, a target input mode (such as the last used input mode) other than the currently used input mode is reserved for rapid switching thereto. Device 10 may provide a first dedicated UI to always switch to the target input mode and a second dedicated UT to switch between the target and the currently used input modes. In other words, the list controllable by the second dedicated UI consists of the currently used input mode and the target input mode.

Variations

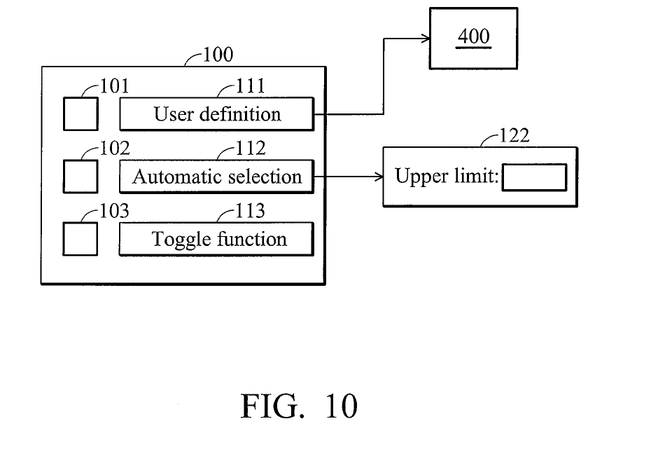

The toggle function may also be used in conjunction with the first or second embodiments, or both. Device 10 may provide a UI for selectively activating the user definition, automatic selection, and toggle functions. For example, GUI menu 100 is displayed on display 9. GUI elements 111, 112, and 113 in FIG. 10 respectively represent these functions. GUI elements 101, 102, and 103 may be respectively utilized to enable or disable corresponding functions. When GUI element 101 enables the user definition function, list 400 is prompted. When GUI element 102 enables the automatic selection function, GUI 122 is presented to receive the upper limit of input modes in the dynamic list. The original input mode list, customized list, the dynamic list, and the switching sequence available through the toggle function may be controlled by different control interfaces (such as different buttons) or the same interface (such as the hash key) assisted with another control for switching them. For example, the input mode list controllable by the hash key may be changed by the assistant control from the original input mode list to the customized list and the dynamic list, and the switching sequence available through the hash key may be changed to the switching sequence in toggle mode.

### CONCLUSION

The available optional input modes may be reduced before or during character input. Reduction of the input mode list may be automatically performed according to utilization of respective input modes. The switching sequence may be automatically adjusted based on input mode usage patterns. Thus, switching between desired input modes becomes much easier and requires less switching operations.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An input mode switching method, implemented in an electronic device, comprising:
providing a plurality of input modes selectable for character input; and
selecting a subset of the input modes as the total options selectable through a first control interface of the device during character input.

2. The method as claimed in claim 1, further comprising providing a user interface for selecting the subset of the input modes when the device activates a user definition function.

3. The method as claimed in claim 2, further comprising, when the device activates a toggle function, the last used input mode in the subset is first presented as the current input mode after the currently used input mode of the device is switched off regardless of the original arrangement of the input modes belonging to the subset.

4. The method as claimed in claim 1, wherein, when the device activates an automatic selection function, the selecting step comprises automatically selecting the subset from the input modes according to the utilization of each input mode.

5. The method as claimed in claim 4, further comprising automatically adding the last used input mode to the subset.

6. The method as claimed in claim 4, further comprising automatically adding the most frequently used input mode to the subset.

7. The method as claimed in claim 6, further comprising:
for each input mode, measuring the duration utilizing the mode is utilized for character input to the device; and
locating the most frequently used input mode based on the measured duration.

8. The method as claimed in claim 6, further comprising:
for each input mode, counting the number of times that the mode is selected for character input to the device; and
locating the most frequently used input mode based on the counted times.

9. The method as claimed in claim 6, further comprising:
for each input mode, counting the number of characters input to the device utilizing the mode; and
locating the most frequently used input mode based on the count.

10. The method as claimed in claim 4, further comprising providing a user interface for reducing a list of the input modes to a downsized menu with less input modes from which the subset is automatically selected.

11. The method as claimed in claim 10, further comprising, when the device activates a toggle function, the last used input mode in the subset is first presented as the current input mode after the currently used input mode of the device is switched off regardless of the original arrangement of the input modes belonging to the subset.

12. The method as claimed in claim 4, wherein the number of input modes included in the subset is limited to a predetermined number.

13. The method as claimed in claim 11, further comprising providing a user interface for setting the predetermined number.

14. The method as claimed in claim 1, wherein the subset comprises the currently used input mode and the last used input mode of the device, and the method further comprises, when the device activates a toggle function, the last used input mode in the subset is first presented as the current input mode after the currently used input mode of the device is switched off regardless of the original arrangement of the input modes.

15. An input mode switching method, implemented in an electronic device, comprising:
providing a plurality of optional input modes for character input, arranged in a predefined sequence to be switched on orderly and exclusively; and
selecting a subset of the input modes by which a new sequence of input mode switching is obtained by the electronic device during character input.

16. An electronic device capable of input mode switching, comprising:
an input device capable of character input via a plurality of optional input modes; and
a processor selecting a subset of the input modes as the total options selectable through a first control interface of the input device during character input.

17. The device as claimed in claim 16, further comprising:
a display showing a user interface for selecting the subset of the input modes when the electronic device activates a user defined function.

18. The device as claimed in claim 16, wherein, when the electronic device activates a toggle function, the processor first presents the last used input mode in the subset as the current input mode after the currently used input mode of the device is switched off regardless of the original arrangement of the input modes belonging to the subset.

19. The device as claimed in claim 16, wherein, when the device activates an automatic selection function, the processor automatically selects the subset from the input modes according to the utilization of each input mode.

20. The device as claimed in claim 16, wherein the electronic device comprises mobile device.
